(19) United States
(12) Patent Application Publication
(10) Pub. No.: US 2009/0066117 A1
(43) Pub. Date: Mar. 12, 2009

(54) Fiberglass hood repair panel

(76) Inventor: Michael Burt Weeks, Lawrenceville, GA (US)

Correspondence Address: Michael Weeks, 650 Old Norcross Road, Lawrenceville, GA, 30045, US

(21) Appl. No.: 11/896,326

(22) Filed: Aug. 31, 2007

(51) Int. Cl. B62D 25/12; B62D 25/10

(52) U.S. Cl. 296/193.11; 428/98

(57) ABSTRACT

The present invention relates to parts and a process for repairing and reinforcing fiberglass automotive and truck hoods. The repair panel is a single part formed to precisely fit the underside of an automotive hood and hood structure. The repair panel may be made of fiberglass, composite, plastic or carbon fiber. The repair panel materials should be able to be formed to closely match the shaped of the hood to be repaired. Repair panel is adhered to the underside of the hood with any adhesive compatible with the material the repair panel and hood are made of. This repair panel and process will work of hoods made of fiberglass, composite, plastic, or carbon fiber.

### FIGURE DESCRIPTIONS

FIG. 1 is a perspective view of a fiberglass hood repair part showing a fiberglass reinforcement member matched to the inside of an automobile hood and ready to be joined to the hood;

FIG. 2 is a perspective of the invention, illustrating is a perspective view of the invention, illustrating the fiberglass hood repair part showing the part showing the part placed onto the hood where the adhesives shows through the fiberglass reinforcement part;

FIG. 3 is a perspective of the invention illustrating the fiberglass hood repair part being lowered to hood and further illustrating clamps holding the fiberglass reinforcement part tight to the hood with adhesive cures; and

FIG. 4 is a perspective of the invention, illustrating is a perspective view of the invention, illustrating the fiberglass hood repair part showing more are clamps fitted to the fiberglass reinforcement part.

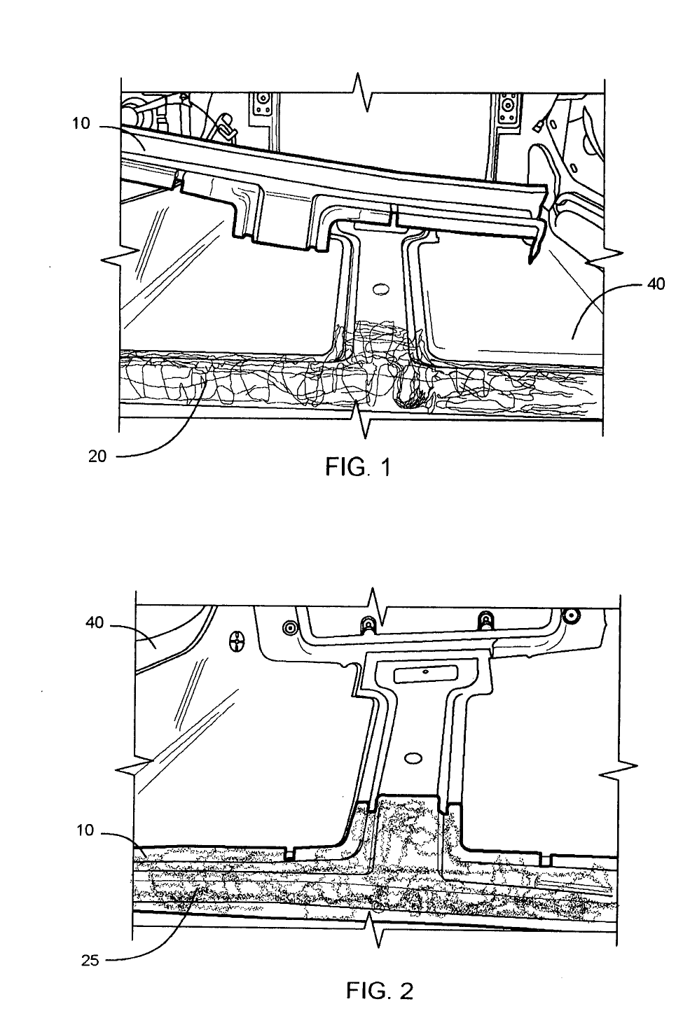

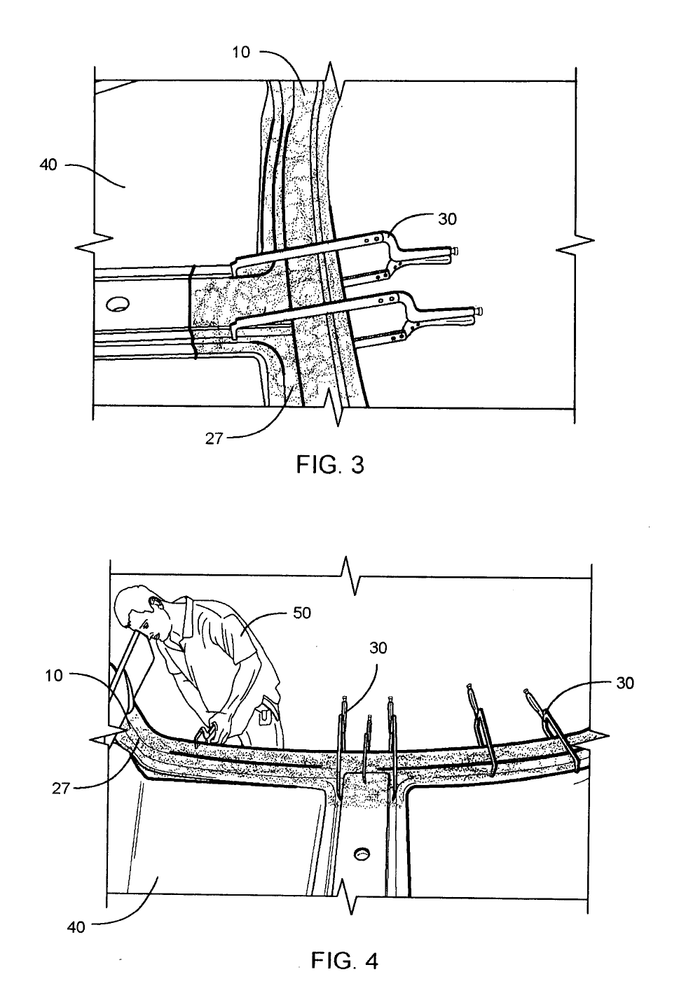

### NUMBER DESCRIPTION LIST

10 is the repair panel.
20 is an adhesive applied to the hood.
25 is the adhesive partially compressed.
27 is the adhesive compressed between the panel hood.
30 is a clamp.
40 is a truck hood shown inverted.
50 is a repairman

### DESCRIPTION

The present invention relates to fiberglass hood repair part and a process whereby a fiberglass vehicle hood is repaired and reinforced.

The repair panel is a single part formed to precisely fit the underside of a fiberglass hood and hood structure.

Repair panel may be made of fiberglass, composite plastic or carbon fiber. The construction materials should be shapeable and be able to be formed to closely match the shape of the hood to be repaired and then harden to become rigid. Repair panel thickness can vary depending on strength needed or repair panel material. Maximum thickness is determined by the particular hood and vehicle being repaired.

Repair panel is adhered to the underside of the hood with any adhesive compatible with the material the repair panel and hood are made of.

This repair panel and process will work on hoods made of fiberglass, composite, plastic, or carbon fiber.

What is claimed is:

1. I claim: Hood repair panel for repairing and reinforcing automotive and truck hoods; the repair panel is formed to precisely fit the shape of the underside of the hood to be repaired.

2. The invention of claim 1 wherein the repair pane is made of carbon fiber.

3. The invention of claim 1 wherein the repair panel is made of plastic.

4. The invention of claim 1 wherein the repair panel is adhered to the underside of the hood to be repaired.
